(19) United States
(12) Patent Application Publication
(10) Pub. No.: US 2002/0129506 A1
(43) Pub. Date: Sep. 19, 2002

(54) Device for gear checking measurement

(76) Inventor: Sil Han, Wilmette, IL (US)

Correspondence Address: Leighton K. Chong, Ostrager Chong & Flaherty (Hawaii), Suite 1200, 841 Bishop Street, Honolulu, HI, 96813, US

(21) Appl. No.: 09/844,185

(22) Filed: Apr. 25, 2001

Related U.S. Application Data
(60) Provisional application No. 60/199,575, filed on Apr. 25, 2000.

(51) Int. Cl. G01B 3/50

(52) U.S. Cl. 33/501.7

(57) ABSTRACT

A device and method for gear checking measurement of a gear employs a pair of measuring pins or balls of predetermined outer diameter which are placed in tooth spaces on diametrically opposite sides. The measuring pins or balls are held in the tooth spaces by a holding element which is fixedly connecting to and spaced from each measuring pin or ball in a direction along the gear axis so that an accurate measurement can be taken of the overall external diameter over the measuring pins. In one version, the holding element is a separate magnet or pair of magnets coupled to a respective measuring pin or ball. In another version, a holder frame holds a pair of measuring pins or balls at circumferential positions with a pre-counting spacing of gear teeth on diametrically opposite sides of the gear.

This U.S. patent application claims the priority of U.S. Provisional Application No. 60/199,575 of the same inventor filed on Apr. 25, 2000.

### TECHNICAL FIELD

This invention generally relates to precision checking of gears, and particularly, to a device for facilitating accurate measurement of the external diameter of a gear.

### BACKGROUND OF INVENTION

The conventional method of checking helical or spur gear sizes involves positioning two cylindrical pins or balls of predetermined diameter in the tooth spaces on diametrically opposite sides of a gear. If the gear has an odd number of teeth, the wires are located as nearly opposite as possible. An overall measurement M is taken from the external surfaces of the pins or balls. The measurement is then compared against pre-determined tables of what the measurement should be when the gear's external diameter is correct and there is no allowance for backlash.

However, in using the conventional gear measurement method, it is difficult to place the pins (or balls) in the tooth spaces, and to maintain them there for accurate measurement. Also, if the gear has a large number of small teeth, placing the pins in the correct tooth spaces requires counting the exact number of teeth for diametrically opposite placement each time a gear is checked, which can be subject to error and is time consuming.

### SUMMARY OF INVENTION

The present invention seeks to solve the problems of the conventional gear checking measurement method by providing a device and method that will ensure that the measuring pins (or balls) can be placed without error and securely in position for an accurate measurement.

In accordance with the invention, a device for gear checking measurement of a gear having a plurality of teeth arranged circumferentially on an external surface of the gear around a central axis thereof and formed with corresponding tooth spaces between adjacent teeth which have a given depth into the gear and extend a given length along the surface of the gear in a direction along the gear axis, comprises:

(a) a pair of measuring pins or balls each having a predetermined outer diameter which are adapted to be placed in diametrically opposite tooth spaces of the gear; and

(b) a holding element for holding each of said measuring pins or balls in the tooth spaces of the gear, and a spacer or linking element fixedly connecting the holding element to each respective measuring pin or ball such that the holding element is spaced from said pin or ball in a direction along the gear axis so that an accurate measurement can be taken of the overall external diameter over the measuring pins in the diametrically opposite tooth spaces of the gear.

In one preferred version, the holding element is a separate magnet for each measuring pin or ball having an outer diameter corresponding to that of the measuring pin or ball so that the magnet can be laid in the respective tooth space to hold the measuring pin or ball therein. In other versions, a pin or ball holder frame holds a pair of measuring pins or balls at circumferential positions corresponding to the desired number of tooth spaces separating the pins or balls on diametrically opposite sides of the gear.

Other objects, features, and advantages of the present invention will be explained in the following detailed description of the invention having reference to the appended drawings.

### BRIEF DESCRIPTION OF DRAWINGS

FIGS. 1A and 1B are top and front views illustrating one version of a pair of measuring balls for gear checking measurement in accordance with the invention, and

FIG. 1C is a detail view of the ball holding assembly.

FIGS. 2A and 2B are top and front views illustrating another version of measuring pins for gear checking measurement, and

FIG. 2C is a detail view of the pin holding assembly.

FIGS. 3A and 3B are top and front views illustrating another version of measuring balls using a ball holder frame for gear checking measurement, and

FIG. 3C is a detail view of the ball holding assembly.

FIGS. 4A and 4B are top and front views illustrating another version of measuring pins using a pin holder frame for gear checking measurement.

FIGS. 5A and 5B are top and front views illustrating another version of two pairs of measuring pins using a pin holder frame around the entire circumference of the gear.

### DETAILED DESCRIPTION OF INVENTION

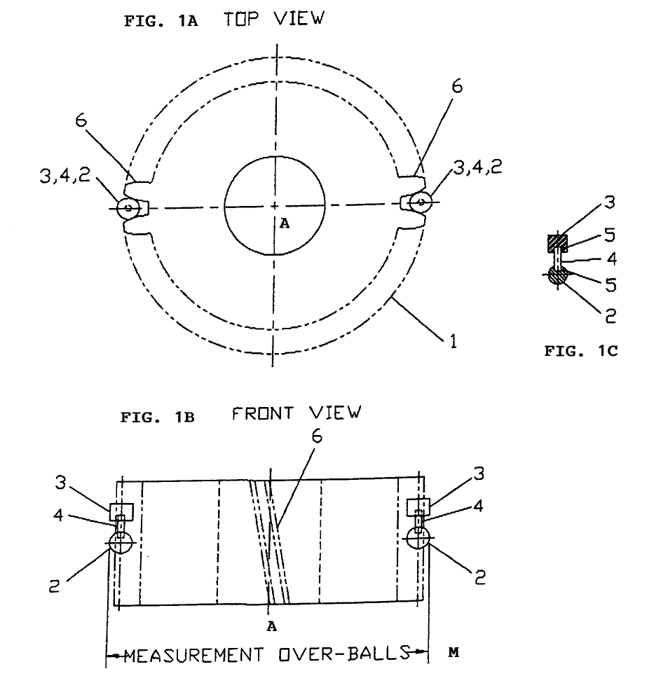

Referring to FIGS. 1A to 1C, a helical gear 1 has a plurality of teeth 6 arranged circumferentially on an external surface of the gear 1 around a central axis A and formed with corresponding tooth spaces between adjacent teeth which have a given depth into the gear and extend a given length along the surface of the gear in a direction along the gear axis. A pair of precision gauge balls 2 have a predetermined outer diameter which is used for the gear checking measurement. The balls 2 are positioned in the tooth spaces on diametrically opposite sides of the gear 1. The balls are held in the tooth spaces by separate magnets 3 which have the same outer diameter as the balls 2 so that they can be positioned in the tooth spaces with the balls. A linking element such as a rubber rod or steel wire 4 is used to connect the balls 2 to the magnets 3 at a position spaced from each other. The ends of the rod or wire 4 can be fixed by adhesive bonding 5 in holes or otherwise fixedly attached to the respective elements. Since the magnetic holding element is spaced from the ball, the gear checking measurement M can then be taken over the outside surfaces of the balls.

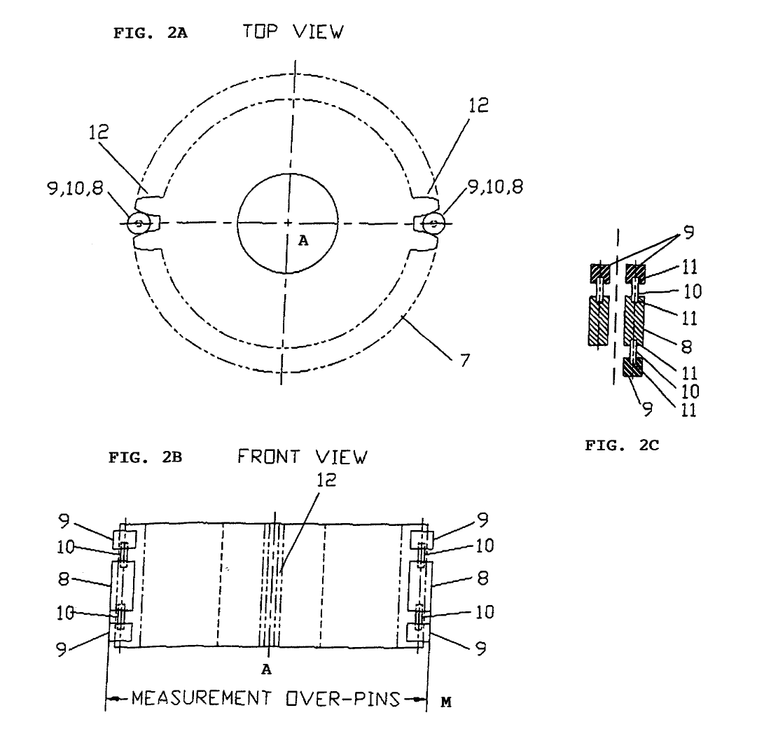

In another version shown in FIGS. 2A to 2C, a spur gear 7 has a plurality of teeth 12 arranged circumferentially on the gear around central axis A. A pair of precision gauge pins 8 are positioned for the gear checking measurement on diametrically opposite sides of the gear 12. The pins are held in the tooth spaces by one or a pair of magnets 9 which have the same outer diameter as the pins 8 so that they can be positioned in the tooth spaces. Linking elements 10 are fixed by adhesive bonding 11 in holes or otherwise fixedly attached to the respective elements. Once again, the gear checking measurement M can then be taken over the outside surfaces of the pins.

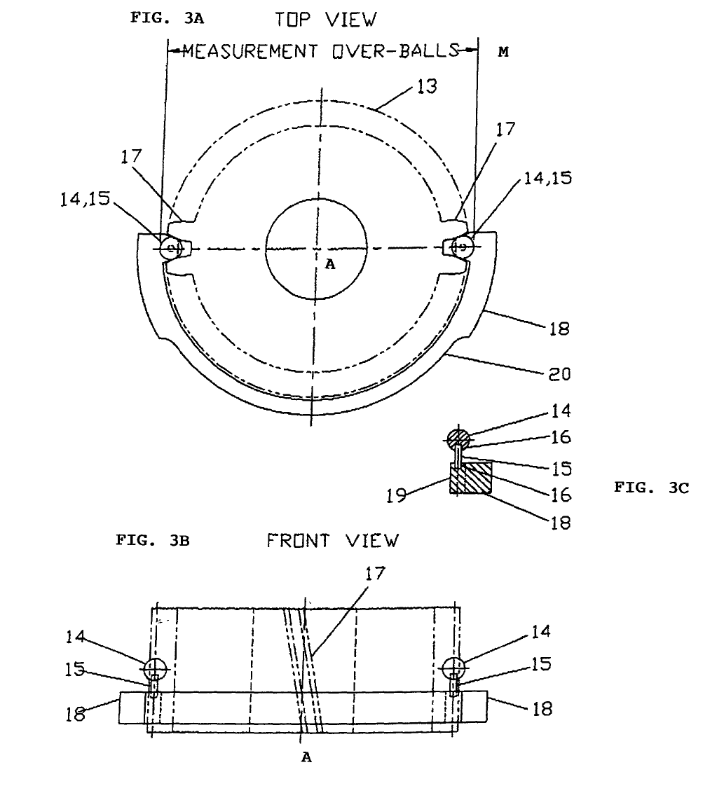

In FIGS. 3A to 3C, another version of the device and method of the present invention employs a ball holding frame 18 for holding a pair of measuring balls 14 at circumferential positions corresponding to the desired number of tooth spaces separating the balls on diametrically opposite sides of the gear 13. The balls are seated in the tooth spaces between teeth 17 at the indicated positions. The ball holding frame 18 is preferably formed with a somewhat flexible spring section 20 and more rigid ball-holding portions 19, so that the balls can be flexibly positioned at the correct circumferential positions, then held securely in the tooth spaces. The holding elements 19 and balls 14 are connected by linking elements 15 held by adhesive bonding 16 to the respective elements.

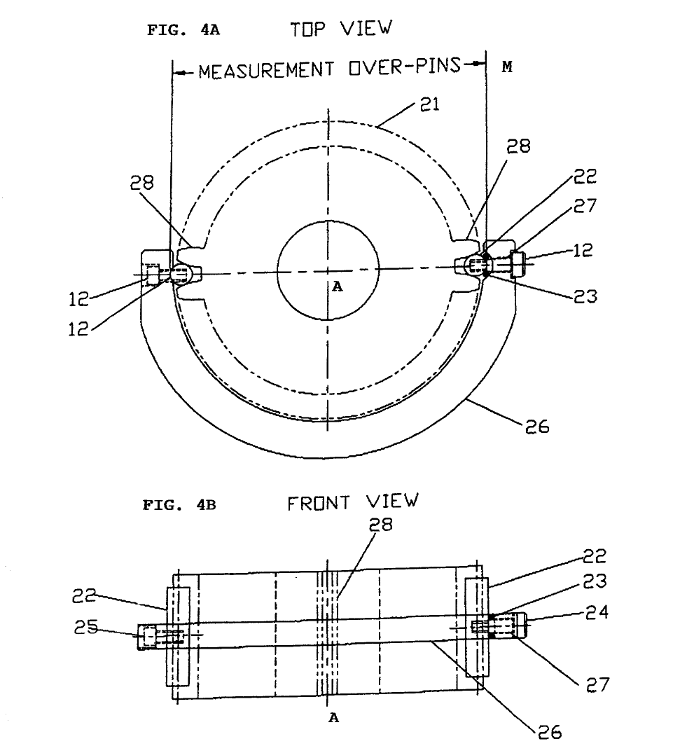

In FIGS. 4A to 4B, another version of the holding frame 26 holds a pair of measuring pins 22 at circumferential positions corresponding to the desired number of tooth spaces separating the measuring positions on diametrically opposite sides of the gear 21. The pins are seated in the tooth spaces between teeth 28 by the pin holding frame 26. The holding elements are formed by mounting screws 24, 25 having ends secured to a middle portion of the pins and held to the pin holding frame by O-rings 23 and by engagement in countersunk recesses 27.

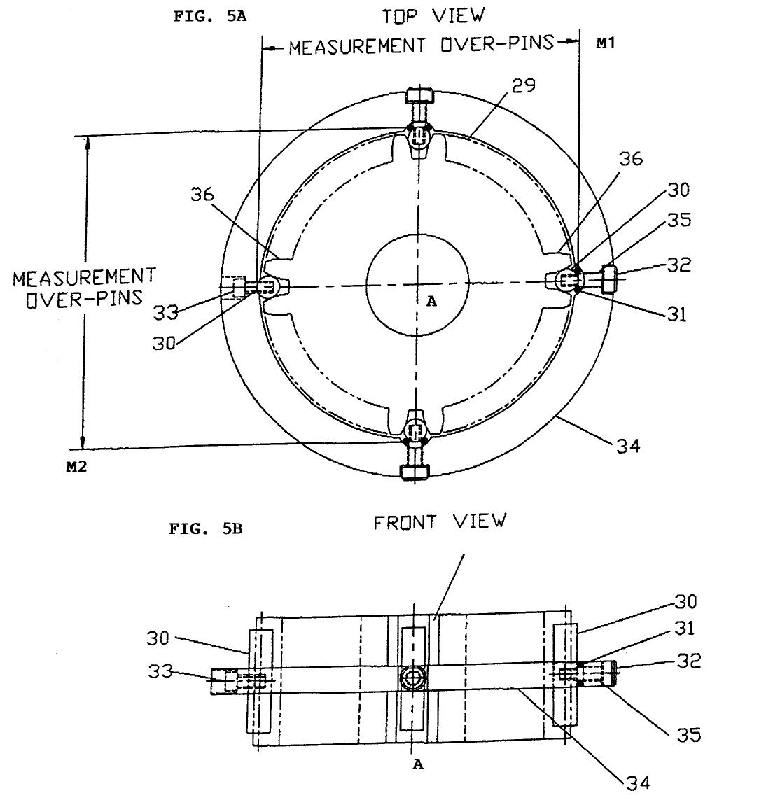

In FIGS. 5A to 5B, yet another version of the holding frame 34 holds two pairs of measuring pins 30 at respective circumferential positions corresponding to the desired number of tooth spaces separating four measuring positions on opposite sides of the gear 29 in mutually perpendicular directions. The holding elements are formed by mounting screws 32, 33 having ends secured to a middle portion of the pins and held to the pin holding frame by O-rings 31 and by engagement in countersunk recesses 35. The 4-pin device allows orthogonal gear checking measurements M1 and M2 to be taken.

It is understood that many modifications and variations may be devised given the above description of the principles of the invention. It is intended that all such modifications and variations be considered as within the spirit and scope of this invention, as defined in the following claims.

I claim:

1. A device for gear checking measurement of a gear having a plurality of teeth arranged circumferentially on an external surface of the gear around a central axis thereof and formed with corresponding tooth spaces between adjacent teeth which have a given depth into the gear and extend a given length along the surface of the gear in a direction along the gear axis, comprising:
(a) a pair of measuring pins or balls each having a predetermined outer diameter which are adapted to be placed in diametrically opposite tooth spaces of the gear; and
(b) a holding element for holding each of said measuring pins or balls in the tooth spaces of the gear, and a spacer or linking element fixedly connecting the holding element to each measuring pin or ball such that the holding element is spaced from said pin or ball in a direction along the gear axis so that an accurate measurement can be taken of the overall external diameter over the measuring pins in the diametrically opposite tooth spaces of the gear.

2. A device for gear checking measurement according to claim 1, wherein the holding element is a separate magnet for each measuring pin or ball having an outer diameter corresponding to that of the measuring pin or ball so that the magnet can be laid in the respective tooth space to hold the measuring pin or ball therein.

3. A device for gear checking measurement according to claim 2, wherein the linking element is a wire or rod fixedly connecting the magnet to the respective measuring pin or ball.

4. A device for gear checking measurement according to claim 1, wherein the holding element is a pair of magnets for holding each measuring pin or ball, said pair of magnets being spaced on opposite sides of the pin or ball along the direction of the gear axis.

5. A device for gear checking measurement according to claim 1, wherein the gear is a spur gear.

6. A device for gear checking measurement according to claim 1, wherein the gear is a helical gear.

7. A device for gear checking measurement according to claim 1, wherein the holding element is a pin or ball holding frame for holding a pair of measuring pins or balls at circumferential positions corresponding to the desired number of tooth spaces separating the measuring positions on diametrically opposite sides of the gear.

8. A device for gear checking measurement according to claim 7, wherein the pin or ball holding frame is formed with a flexible, spring-like intermediate portion and a pair of rigid holding portions for holding the respective pins or balls.

9. A device f or gear checking measurement according to claim 7, wherein the holding frame is a ball holding frame having holding elements spaced from the respective balls and linking elements of wire or rod elements.

10. A device for gear checking measurement according to claim 7, wherein the holding frame is a pin holding frame have holding elements formed by mounting screws which have distal ends secured to a middle portion of the respective pins and proximate ends held to the pin holding frame by O-rings and by engagement in countersunk recesses.

11. A device for gear checking measurement according to claim 7, wherein the holding frame holds two pairs of measuring pins or balls at four circumferential positions on diametrically opposite sides of the gear which are mutually perpendicular to the other, in order to enable two gear checking measurements over the respective pairs of measuring pins or balls.

12. A method for gear checking measurement of a gear having a plurality of teeth arranged circumferentially on an external surface of the gear around a central axis thereof and formed with corresponding tooth spaces between adjacent teeth which have a given depth into the gear and extend a given length along the surface of the gear in a direction along the gear axis, comprising:
(a) placing a pair of measuring pins or balls each having a predetermined outer diameter in diametrically opposite tooth spaces of the gear; and
(b) providing a holding element for holding each of said measuring pins or balls in the tooth spaces of the gear, said holding element being fixedly connected to and spaced from each measuring pin or ball in a direction along the gear axis so that an accurate measurement can be taken of the overall external diameter over the measuring pins in the diametrically opposite tooth spaces of the gear.

13. A method for gear checking measurement according to
